(19) United States
(12) Patent Application Publication
(10) Pub. No.: US 2005/0084106 A1
(43) Pub. Date: Apr. 21, 2005

(54) System for providing time dependent conditional access

(76) Inventors: Jilles Venema, Eindhoven (NL); Franciscus Lucas Antonius Johannes Kamperman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,167

(22) PCT Filed: Dec. 9, 2002
(86) PCT No.: PCT/IB02/05327

(30) Foreign Application Priority Data
Jan. 14, 2002 (EP) 02075143.4

(51) Int. Cl. H04N 7/167

(52) U.S. Cl. 380/239

(57) ABSTRACT

A source transmits (10) successive keys encrypted in encryption control messages and information in an encrypted form at is successively decryptable with the successive keys. A decoder (122) decrypts the information. A secure device (14) receives the encryption control messages, decrypts the keys from the messages and supplies the keys to the decoder (122). The secure device (14) maintains a time value. The secure device (14) controls the supply of the keys dependent on the time value, and increments the time value in response to reception of respective ones of the encryption control messages.

The invention relates to a system and method of providing conditional access to a stream of media information, and to a secure device for use in such a system.

It is well known to use encryption to facilitate conditional access to media information such as video and audio signals. A receiving station is given access to the information by supplying the decryption key for decrypting the information. Only entitled subscribers are provided with a key. Keys are conventionally distributed using a smart card (or more generally a secure device, which is protected against tampering by unauthorized persons).

A commonly applied key distribution scheme transmits three types of information: encrypted content, Encryption Control Messages (ECM's) and Encryption Management Messages (EMM's). The content is encrypted so that different keys are needed in successive time intervals to decrypt the content. The secure device supplies these keys under control of the ECM's and EMM's. An ECM is transmitted each time when the key to decrypt the content has to be changed. The ECM contains the key in encrypted form, so that the secure device can decrypt the key from the ECM.

However, the secure device will supply the decrypted key only if it is entitled to do so. The entitlement is determined from entitlement information in the secure device and records for example, whether the subscriber that holds the secured device may decrypt in formation at all, or if so which types of content may be decrypted. The secure device supplies keys only for those types of information. The entitlement information is updated under control of the EMM's, which are normally transmitted less frequently than the ECM's.

From European Patent Application No. 635 790 it is known to provide time dependent conditional access. The secure device of this publication contains a Time Of Day clock, which counts a time value that represents an absolute time. The secure device compares a time interval in which a subscriber has been granted access to information with the time value. Access is allowed only when the time value is in the time interval. Thus, when access is allowed only during a trial period, it can be prevented that the subscriber gains access outside the trial period.

For the operation of time dependent conditional access it is important that the time value of the time of day clock cannot be tampered with. According to European Patent Application No. 635 790 this is realized by periodically transmitting authenticated time stamps to the secure device. The secure device checks the authorization of the time stamps and updating the time value of the time of day clock according to the authorized time stamps. Between successive updates the clock changes the time values according to a local count of time. However, to prevent that clock drift compromises the reliability of the clock, the device prevents its use for granting access when it has not been updated with a time stamp for a predetermined time interval.

Although this device provides for time dependent conditional access it has some drawbacks. First of all, the clock has to run continuously, which can be impractical in secure devices such as smart cards and is moreover sensitive to tamper attempts to change clock speed. Secondly, this scheme is not resistant to tamper attempts in which the time stamps are intercepted, stored and supplied to the secure device with a delay.

Amongst others, it is an object of the invention to provide for a system and method of conditional access, which has other protection against tampering with time dependent conditional access.

More in particular, it is an object of the invention to provide such a system and method in a system that receives continuous streams of encrypted content and encryption control messages.

It is another object to provide for such a system and method in which no continuously running clock is needed.

The invention provides for a system according to claim 1. According to the invention, the time value is updated in response to the reception of encryption control messages. The subscriber is forced to allow these updates if he or she wants to access the encrypted contents and no special information is needed to make normal clock updates. In principle, an internal clock oscillator could be used in the secure device to advance the clock independently between encryption control messages to realize an even more reliable clock. But the reliability is reduced only slightly if these updates or even the oscillator are omitted, because the use of encryption control messages from a continuous media stream ensures regular updates. This leads to a less complex (and costly) structure for the secure device (which is preferably a smart card, without its own power supply).

The time value could simply be incremented by a fixed amount each time an encryption control management message is received, if one can rely on the fact that the encryption control messages are incorporated in the media stream on average with a predictable frequency. In an embodiment of the system according to the invention, a time-stamp from the encryption control messages, which serves to check entitlement to use the key in the message are also used to update the time value in the secure device. In an embodiment, the time-value is set to the value of the time-stamp, or a value corresponding to it, provided the new value is later than the old time value.

In a further embodiment, the difference between timestamps of successive encryption control messages is determined, and the time value in the secure device is incremented according to this difference. This is particularly useful if the system allows viewing content with a time-shift (i.e. to view old content, that has been stored in the system for some time, say from the afternoon to the evening). By using differences it is still possible to ensure reliable time values when content is decrypted with a time shift, without having to access a “live” stream of time stamps as frequently as the encryption control messages arrive.

In another embodiment, time-stamps from less frequent encryption management message from a live stream are used to set the absolute value of the time value in the secure device (i.e. not differentially). For this purpose the secure device may have to monitor both a live media stream and a time shifted stream to decrypt the time shifted stream, but this involves little overhead, since from the live stream only encryption management messages need to be interpreted. Thus, errors in the time stamps of encryption control messages can be corrected (these errors might be uncorrectable since the secure device prevents that the time value can be set back by an encryption control message, even if the time value has been set forward due to an error). Even when the time stamps from the encryption control messages are not used, such use of time stamps from encryption control messages helps to increase protection against tampering with the time value, since tampering would have to involve coordinating a number of streams.

In a further embodiment the user is forced to allow the secure device to copy time-stamps from the encryption management messages because the secure device is arranged to allow updates by means of encryption control messages only for a predetermined number of times after receiving an encryption management message, if no new encryption management is received with a later time stamp. This will increase security of the time value if encryption control messages are used to update the time value in general, but particularly if decoding of time shifted streams is allowed, because it forces the user to supply a live stream as well during decryption of the time-shifted stream. Management information from the live stream will thus be processed by the secure device even if a time-shifted stream is decoded, allowing updates to entitlements. Separately from this, obligatory use of encryption management messages from the live stream allows correction of the time value if a time stamp from an encryption control message has lead to an erroneous time value.

These and other objects and advantageous aspects of the system and method according to the invention will be discussed in more detail using the following figure.

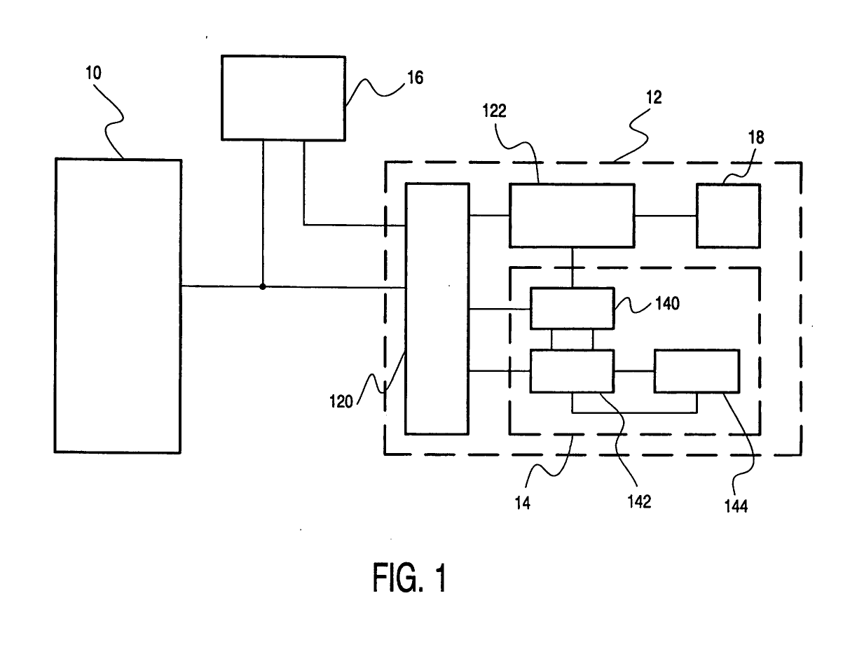

FIG. 1 shows a system for providing conditional access.

FIG. 1 shows a system for providing conditional access. The system contains a source 10 of an encrypted media stream, a conditional access apparatus 12 and a storage device 16 (for example a magnetic or optical disk or a tape recorder). The source 10 has an output coupled to the conditional access apparatus 12 and the storage device 16. The storage device 16 has an output coupled to the conditional access apparatus 12.

The conditional access apparatus 12 contains a receiving section 120, a content decoder 122, a rendering device 18 and a secure device 14 (for example a smart card). The receiving section 120 receives inputs from the source 10 and the storage device 16 and has an output for encrypted content coupled to the content decoder 122, and outputs for encryption control messages (ECM's) and encryption management messages (EMM's) coupled to secure device 14 (although shown separately, the latter outputs may in fact be combined into a single output). The secure device 14 has an output coupled to a key input of decoder 112. Decoder 122 has an output for decrypted content coupled to rendering device 18.

Secure device 14 contains a decryption unit 140, a management unit 142 and time value storage 144. Decryption unit 140 has an input coupled to the output for ECM's of the receiving section and an output coupled to the key input of decoder 122. Decryption unit 140 also has an output for time stamps coupled to management unit 142. Management unit 142 has an input coupled to the output for EMM's of the receiving section 120. Furthermore management unit 142 has inputs and outputs coupled to time value storage 144. Separate inputs are shown for EMM's and ECM's but of course these may be supplied via a single input and processed separately in the secure device 14.

In operation, source 10 transmits one or more streams of encrypted media information (for example video and/or audio information). Each stream contains encrypted content, encryption control messages (ECM's) and encryption management messages (EMM's). The bandwidth requirements for these items differs widely: the content may require a permanent bandwidth of several megabits per second, whereas ECM's may require less than a kilobit and are transmitted, say, only once every minute. EMM's are transmitted even less frequently, say, once per hour. The encryption control messages contain keys for decrypting the encrypted content. These keys themselves are also encrypted. The encryption control messages preferably also contain time stamps. These time stamps may be encrypted, but this is not necessary. It suffices that they are authorized, i.e. encoded in such a way that it can be verified that reasonably only the source could have supplied the time-stamps and that an ECM is associated with a specific time stamp.

Conditional access apparatus 12 receives at least one of the streams. Receiving section 120 passes encrypted content from this stream to decoder 122. Receiving section 120 passes ECM's and EMM's from the stream to secured device 14. Secure device 14 decrypts keys from the ECM's and conditionally supplies them to decoder 122. With the keys, decoder 122 decrypts the content and supplies the decrypted content to rendering device 18, which contains for example a display screen and or a loudspeaker and which renders the content so that the content can be perceived by the user of the system.

Secure device 14 checks whether it is entitled to supply the keys to decoder 122. At least for some of the keys entitlement depends on time. Management unit 142 enforces time dependent entitlement using a time value from time value storage 144 and optionally using a time stamp from a received ECM. In its simplest form, management unit 142 compares the time value with a range of times for which secure device 14 is enabled. Thus, for example, keys may be supplied only in periods for which the user has paid. In a more complicated form entitlement may be related to the time-stamp of the ECM, allowing the supply of keys for example only if the difference between the time value and the time-stamp is within a certain range. Thus, for example, one could entitle the user to view only live content, but not time-shifted (recorded) content, or, on the contrary only to view content that has been delayed for a certain period. This allows differential subscription fees, dependent on service level.

Thus, by means of the time values and the time stamps in the entitlement control messages the system can distinguish between live information received from the source 10 and time shifter information received from storage device 16.

The time value in time value storage 144 is regularly updated by management unit 142. According to the invention, this is preferably done each time when an ECM is received (or each time a predetermined number of ECM's has been received). In a simple embodiment, the management unit 142 increases the time value by a fixed amount for each received ECM for which the time value is altered.

In a more advanced embodiment, management unit 142 compares the time value with the time-stamp of the ECM and sets the time value to a time corresponding to that time value, provided that the new time value encodes a later time than the stored time value in time value storage 144.

In yet another embodiment, management unit 142 computes the new time value that it stores in time value storage 144 by adding an increment to the old time value from time value storage 144. Management unit 142 computes the increment by additionally storing information from the time-stamp of a previous ECM for which the time value is incremented, and determining the difference between the times represented by the time stamp of the current ECM and this previous ECM. From this difference management unit 142 determines the size of the increment and adds the increment to the old time value to determine the new time value, provided the increment is positive. The incremented time value is stored in time value storage 144. Additionally the time stamp of the current ECM is stored to enable computation of the difference for a future ECM. Thus, it is also possible to use time-shifted streams to determine the increment.

Preferably, the management unit also uses time-stamps from the EMM's to update the time value in time value storage 144. The EMM's are distinguished from the ECM's in that they are transmitted less frequently (because they do not need to supply keys for the encrypted content) and in that they contain management information, for example to set the type and times content for which the secure device 14 is entitled to supply keys. Thus, the EMM's are essential for controlling the conditions of access, but not directly for providing access. Preferably, the secure device 14 forces the user to supply EMM's by disabling the use of the time value in time value storage 144 for the authorization of issuing of decrypted keys when a number of ECM's has been received in a time-interval without receiving a new EMM's in the same time interval. That is, by disabling the supply of any keys to decoder 122, if the supply is conditional on the time value. For example, if an EMM is transmitted every hour and ECM's are transmitted every minute, the time value may be disabled if more than 60 ECM's have been received without receiving any EMM.

In a further embodiment, management unit 142 uses time stamps from the EMM's to set the time value in time value storage 144. This setting may be protected so that the time value may only increase as compared with the latest time value set by a previous EMM. For this purpose, management unit 142 may store the time-stamp (or information representing it) of the previous EMM and compare this stored time-stamp with the time stamp of the new EMM before setting the time value. Thus errors in the time value (caused for example by erroneous ECM's) can be corrected.

In a further embodiment, conditional access apparatus 12 allows the use of a stored stream from storage device 16. Of course, the ECM's of this stream will contain time-stamps that are older than the time value in time value storage, but the entitlement information in management unit 142 may provide for supplying keys for such “old” streams. The effect of this is that the EMM's and ECM's of the old stream will be supplied to the receiving section 120 from storage device 16. According to the invention the receiving section is arranged to receive a live stream together with the old stream, to extract EMM's from the live stream and to supply these EMM's to secure device 14. Management unit 142 receives these EMM's and uses time-stamps and management information from these EMM's to update the entitlements and the time value in time value storage 144. Thus, it is ensured that the time value is controlled by “live” time-stamps from the EMM, while at the same time recorded (time-shifted) content is processed. The increments in the time values may be controlled by the ECM's of the recorded stream. Thus no ECM's from the live stream need to be processed for this purpose.

Although the decryption unit 140, management unit 142 and time value storage 144 have been shown separately, it will be appreciated that these functions may in fact be combined to a large extent, for example in a micro-processor, the time value being stored in a register. Instead of a register any other kind of storage may be used, for example a location in a memory, or a counter, which updates the time value by means of, pulses from a clock. Management of entitlement and time values may be controlled using a computer program executed by this micro-processor, but of course dedicated hardware may also be used to perform the relevant functions.

1. A system for providing time dependent conditional access to information, the system comprising
a source sub-system (10) arranged to provide
successive keys encrypted in encryption control messages and
the information in an encrypted form that is successively decryptable with the successive keys;
a decoder (122) for decoding the information, with an input for receiving the keys;
a secure device (14) arranged for receiving the encryption control messages, decrypting the keys from the messages and supplying the keys to the decoder (122), the secure device (14) maintaining a time value, the secure device (14) being arranged to control the supply of the keys dependent on the time value, wherein the secure device (14) is arranged to increment the time value in response to reception of respective ones of the encryption control messages.

2. A system according to claim 1, wherein the source sub-system (10) is arranged to include time-stamps in the encryption control messages, the secure device (14) being arranged to decide whether to supply the keys dependent on a comparison between the time-stamps and the time value, the secure device (14) being arranged to control a size of the update according to the time-stamp, with a limitation to increases in the time value.

3. A system according to claim 2, the secure device (14) being arranged to determine a difference between the time stamp of a current encryption control message and a further time stamp of a preceding encryption control message and to increase the time value with said difference.

4. A system according to claim 2, wherein the source sub-system (10) is arranged to transmit encryption management messages at a lower frequency than said encryption control messages, the encryption management messages comprising time stamps, the secure device (14) being arranged to set the time value according to the time stamps in response to receiving the encryption management messages, conditional upon receiving increasing time stamps.

5. A system according to claim 4, arranged to process the content and encryption control messages from a time shifting memory (16), and to substitute encryption management messages from a live stream for encryption management messages from the time shifting memory (16).

6. A system according to claim 1, wherein the source sub-system (10) is arranged to transmit encryption management messages at a lower frequency than said encryption control messages, the encryption management messages comprising time stamps, the secure device (14) being arranged to set the time value according to the time stamps in response to receiving the encryption management messages, conditional upon receiving increasing time stamps.

7. A system according to claim 6, arranged to process the content and encryption control messages from a time shifting memory (16), and to substitute encryption management messages from a live stream for encryption management messages from the time shifting memory.

8. A system according to claim 6, wherein the secure device (14) is arranged to disable supplying of the successive keys dependent on the time value when a predetermined number of the encryption control messages has been received after receiving a first one of the encryption management messages with a first one of the time stamps without receiving any subsequent second one of the encryption management messages with a second one of the time stamps for a time that follows a time of the first one of the time stamps.

9. A method of for providing time dependent conditional access to information, the method comprising
transmitting successive keys encrypted in encryption control messages and the information in an encrypted form that is successively decryptable with the successive keys;
receiving the encryption control messages
maintaining a time value, incrementing the time value in response to reception of respective ones of the encryption control messages;
decrypting the keys from the messages;
controlling a supply of the keys to a decoder dependent on the time value.

10. A secure device for providing time dependent conditional access to information, the secure device having
an input for receiving successive keys encrypted in encryption control messages;
a decryption unit for decrypting the keys from the messages;
an output for supplying the keys to a decoder,
a memory for storing a time value, the secure device being arranged to control the supply of the keys dependent on the time value, wherein the secure device is arranged to increment the time value in response to reception of respective ones of the encryption control messages.

11. A computer program product comprising computer instructions for causing a secure device (14) with an input for receiving the encryption control messages to
maintain a time value, incrementing the time value in response to reception of respective ones of the encryption control messages;
decrypt the keys from the messages;
control a supply of the keys to a decoder dependent on the time value.
